(19) United States
(12) Patent Application Publication
(10) Pub. No.: US 2024/0426033 A1
(43) Pub. Date: Dec. 26, 2024

(54) FLASH-SPUN/ELECTROSPUN COMPOSITE SUPERFINE NANOFIBER MATERIAL AND PREPARATION METHOD THEREOF

(71) Applicant: SHANGHAI XUNJIANG TECH CO., LTD, Shanghai (CN)

(72) Inventors: Xinglei ZHAO, Shanghai (CN); Pan JIANG, Shanghai (CN); Ting HUA, Shanghai (CN); Peng WANG, Shanghai (CN)

(73) Assignee: SHANGHAI XUNJIANG TECH CO., LTD, Shanghai (CN)

(21) Appl. No.: 18/827,043

(22) Filed: Sep. 6, 2024

Related U.S. Application Data
(63) Continuation of application No. PCT/CN2023/090727, filed on Apr. 26, 2023.

(30) Foreign Application Priority Data
Apr. 28, 2022 (CN) 202210470343.9

(51) Int. Cl. D04H 1/4382; D01D 5/00; D01D 5/11; D01F 1/10; D01F 6/46; D01F 6/48; D01F 6/54; D01F 6/94; D04H 1/4291; D04H 1/43; D04H 1/4318; D04H 1/4358; D04H 1/558; D04H 1/56; D04H 1/728

(52) U.S. Cl. CPC D04H 1/43838; D01D 5/0038; D01D 5/11; D01F 1/10; D01F 6/46; D01F 6/48; D01F 6/54; D01F 6/94; D04H 1/4291; D04H 1/43; D04H 1/4318; D04H 1/4358; D04H 1/43835; D04H 1/558; D04H 1/56; D04H 1/728; D10B 2321/021; D10B 2321/042; D10B 2321/06; D10B 2321/10; D10B 2331/10; D10B 2401/022; D10B 2401/063; D10B 2401/10

(57) ABSTRACT

In the process of preparing nanofibers by using an electrospinning process and preparing micron fibers by using a flash-spinning process, an electrospinning nozzle and a flash-spinning nozzle are controlled to be located above a receiving conveyor belt, and are directly opposite to each other with a spacing of 15-40 cm, and the electrospinning nozzle is controlled to be connected to a high-voltage power supply, and the flash-spinning nozzle and the receiving conveyor belt are controlled to be grounded to prepare a product; the prepared product has a film-like structure and consists of nanofibers and micron fibers. The micron fibers are mutually entangled, curled and interpenetrated, and the nanofibers are uniformly interspersed and distributed within the micron fibers, some of the nanofibers and the micron fibers forming entangled and interpenetrated structures, with mutual bonding between the nanofibers, between the micron fibers and between the nanofibers and the micron fibers.

### CROSS-REFERENCE TO RELATED APPLICATIONS

This application is a continuation of International Patent Application No. PCT/CN2023/090727 with a filing date of Apr. 26, 2023, designating the United States, now pending, and further claims priority to Chinese Patent Application No. 202210470343.9 with a filing date of Apr. 28, 2022. The content of the aforementioned applications, including any intervening amendments thereto, is incorporated herein by reference.

### TECHNICAL FIELD

The disclosure belongs to a field of new material and new equipment technologies, and relates to a flash-spun/electrospun composite superfine nanofiber material and a preparation method thereof.

### BACKGROUND

An ultra-high molecular weight polyethylene material prepared by single flash-spinning is widely applied to various fields such as medical care, packaging and buildings due to its excellent strength, waterproof performance and air permeability. However, when the ultra-high molecular weight polyethylene material is applied to specific fields, problems of easy delamination, relatively low waterproof performance and relatively low air permeability also limit further development of its performance.

A flash-spinning device and a spinning method thereof are disclosed in Chinese Patent Application No. CN201710805631.4. A secondary drafting technology is provided so that fibers are thinned to enhance performance. However, the entanglement and the porosity of the material prepared in this method are still poor, which cannot fundamentally solve the existing problems.

Therefore, it is of great importance to study preparation of the flash-spun/electrospun composite superfine nanofiber material, so as to solve the problems of easy delamination, relatively low waterproof performance and relatively low air permeability of the original material.

### SUMMARY

In order to solve the problems in the art, a preparation method of a flash-spun/electrospun composite superfine nanofiber material and an enhanced flash-spinning/electrostatic spinning composite device are provided.

In order to achieve the above purpose, the technical solution in the disclosure is as follow:

A preparation method of the flash-spun/electrospun composite superfine nanofiber material, comprises: in the process of preparing nanofibers by using an electrospinning process and preparing micron fibers by using a flash-spinning process, controlling an electrospinning nozzle and a flash-spinning nozzle to be simultaneously located above a receiving conveyor belt, and to be directly opposite to each other with a spacing of 15-40 cm; and controlling the electrospinning nozzle to be connected to a high-voltage power supply, and the flash-spinning nozzle and the receiving conveyor belt to be grounded, to prepare the flash-spun/electrospun composite superfine nanofiber material. If the spacing is too small, strong airflow from flash-spinning will blow away the nanofibers formed by electrospinning. If the spacing is too large, the micron fibers formed by flash-spinning will not be mixed with the nanofibers formed by electrospinning. It needs to be noted that although the electrospinning nozzle is opposite to the flash-spinning nozzle, the electrospun fibers will eventually deposit on the receiving conveyor belt rather than the flash-spinning nozzle. During flash-spinning, strong airflow is generated due to instantaneous pressure release, similar to the pressure release of a pressure cooker, blowing directly opposite the nanofibers, causing the nanofibers to change the direction, so that the nanofibers are irregularly mixed with the flash-spun fibers, and eventually settle onto the conveyor belt under the influence of gravity, and the flash-spun fibers eventually deposit on the receiving conveyor belt rather than on the electrospinning nozzle, because a high electric field generated by electrospinning may charge the flash-spun fibers, and these fibers are driven in a direction opposite to the electric field force, causing them to change the direction under the influence of the electric field force.

In some embodiments, in the preparation method of the flash-spun/electrospun composite superfine nanofiber material, an electrospinning solution includes a polymer I and a solvent I, the polymer I being polyethylene, polyvinylidene fluoride, polyacrylonitrile, polyurethane or polyvinyl butyal, the solvent I being N,N-Dimethylformamide (DMF), Dimethylacetamide (DMAc), dichloromethane, 1H,6H-perfluorohexane, n-pentane or cyclopentane, and the concentration of the polymer I in the electrospinning solution being 2-40 wt %.

In the preparation method of the flash-spun/electrospun composite superfine nanofiber material, the electrospinning solution further includes a water repellent, the water repellent being an organosilicon water repellent, a C6 water repellent or a C8 water repellent, and the concentration of the water repellent in the electrospinning solution being 0.5-5 wt %; the water repellent is added into the electrospinning solution, so that the nanofibers have super-hydrophobic property, with a water contact angle of >150°, and further the hydrophobic property of the flash-spun/electrospun composite superfine nanofiber material is further improved, and the water pressure resistance is higher; similarly, the water repellent may be added into the flash-spinning solution, however, as the fibers formed by flash are in micron level, the diameter between the fibers formed is larger, and the water pressure resistance of the fibers is improved to a limited extent even if the water repellent is added, while as the electrospun fibers are in nano level, the diameter formed is greatly reduced, in which case the water pressure resistance may be greatly improved only by small pores and super-hydrophobicity. Therefore, preferably, the water repellent is only added into the electrospinning solution.

In the preparation method of the flash-spun/electrospun composite superfine nanofiber material, electrospinning process parameters include a liquid flow rate of 1-10 mL/min, a spinning voltage of 30-100 kV, an ambient temperature of 23-25° C., and an ambient relative humidity of 20-90%. The process of electrospinning is as follow: conveying the electrospinning solution into a spinneret plate through an infusion pump, and adding high-voltage electricity on the spinneret plate to generate the nanofibers.

In the preparation method of the flash-spun/electrospun composite superfine nanofiber material, the flash-spinning solution consists of 2-35 wt % of polymer II and a remainder of solvent II. The polymer II is polyethylene, with a melt index of 0.7 g/10 min at a temperature of 160° C. and under a load of 5 kg, and a melting point of 133° C., and the solvent II is dichloromethane, 1H,6H-perfluorohexane, n-pentane or cyclopentane.

In the preparation method of the flash-spun/electrospun composite superfine nanofiber material, flash-spinning process parameters include a reaction pressure of 8-30 MPa, a reaction temperature of 150-300° C., and a stirring speed of 2500-1500 rpm; the process of flash-spinning is as follow: conveying the polymer II and the solvent II into a reaction kettle using an automatic feeding system, pressurizing to 8-30 MPa in the reaction kettle, heating to 150-300° C., upon reaching set parameters, opening a pressure release valve to release pressure instantaneously, and the solution passing through a pressure-drop chamber and being ejected from a spinneret orifice, to form the micron fibers.

In the preparation method of the flash-spun/electrospun composite superfine nanofiber material, during electrospinning, irregular airflow blowing is applied to the jet ejected from the electrospinning nozzle; irregular airflow blowing is applied to the jet ejected from the flash-spinning nozzle.

In the preparation method of the flash-spun/electrospun composite superfine nanofiber material, during electrospinning, the concentration of the solvent in an environment of a spinning region is controlled so that the concentration of the solvent in the environment gradually increases along the jet advancing direction, mainly for the purpose of compensating for decrease of the concentration of the solvent far from the spinneret orifice.

In the preparation method of the flash-spun/electrospun composite superfine nanofiber material, after electrospinning and flash-spinning, hot-pressing is performed on a whole consisting of the nanofibers and the micron fibers at a temperature between the melting point of the nanofibers and the melting point of the micron fibers for 0.2-0.7 min; the purpose of hot-pressing is to generate strong bonding between the fibers; the hot-pressing time shall not be too long, otherwise the fibers will become brittle, and the hot-pressing time shall not be too short, otherwise the effect is not good.

A flash-spun/electrospun composite superfine nanofiber material prepared in the preparation method of the flash-spun/electrospun composite superfine nanofiber material is further provided in the disclosure. The flash-spun/electrospun composite superfine nanofiber material as a whole has a film-like structure and consists of nanofibers and micron fibers. The micron fibers are mutually entangled, curled and interpenetrated, and the nanofibers are uniformly interspersed and distributed within the micron fibers, some of the nanofibers and the micron fibers forming entangled and interpenetrated structures, with mutual bonding between the nanofibers, between the micron fibers and between the nanofibers and the micron fibers, and the mass ratio of the nanofibers to the micron fibers being 1:5-2.5.

In some embodiments, for the flash-spun/electrospun composite superfine nanofiber material, an average diameter of the nanofibers is 50-800 nm, and an average diameter of the micron fibers is 1-20 km; the strength of the flash-spun/electrospun composite superfine nanofiber material (the test method refers to GB/T328.9-2007) is >100 N/50 mm, the porosity is >55%, the moisture permeability (the test method refers to GB/T17146) is >800 g/m² 24 h, and the water pressure resistance (the test method refers to GB/T 4744-2013) is >5 kPa.

An enhanced flash-spinning/electrospinning composite device is further provided in the disclosure, and includes a flash-spinning device, an electrospinning device and a grounded receiving conveyor belt.

The flash-spinning device includes a flash-spinning spinneret unit, the flash-spinning spinneret unit including a grounded first nozzle; the electrospinning device includes a high-voltage power supply and an electrospinning spinneret unit, the electrospinning spinneret unit including a second nozzle connected to the high-voltage power supply.

The first nozzle and the second nozzle are controlled to be simultaneously located above a receiving conveyor belt directly opposite each other with a spacing of D ranging 15-40 cm, If the spacing is too small, strong airflow from flash-spinning will blow away the nanofibers formed by electrospinning. If the spacing is too large, the micron fibers formed by flash-spinning will not be mixed with the nanofibers formed by electrospinning.

In some embodiments, for the enhanced flash-spinning/electrospinning composite device, the flash-spinning device further includes a first blowout device, and the electrospinning device further includes a second blowout device; the first blowout device functions to irregularly eject the micron fibers produced by flash-spinning, so that there are more entangled structures between the micron fibers formed, and the cohesive force between the micron fibers after hot-pressing is greatly enhanced, and the strength of the fiber material is improved; the second blowout device also functions to irregularly eject the nanofibers prepared by electrospinning, so that the nanofibers are caused to be entangled with each other and the nanofibers to be entangled with the flash-spun fibers.

The first blowout device or the second blowout device includes an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the outer cylinder is provided with an air inlet, and the air inlet is connected to the air supply device outside the outer cylinder through an air inlet pipe; and a plurality of jet orifices are irregularly distributed on the inner cylinder.

A spacing between a vertical plate II of a first blowout device 4 and a vertical plate II of a first blowout device 12 is X, where X>0.

The vertical plate I of the first blowout device is fitted onto the first nozzle so that a jet from the first nozzle enters the inner cylinder of the first blowout device; since irregular airflow enters in the inner cylinder, the direction of the jet forming fiber bundles may be changed so that the jet is ejected irregularly; the vertical plate I of the second blowout device is fitted onto the second nozzle, so that a jet ejected from the second nozzle enters the inner cylinder of the second blowout device, and since irregular airflow enters in the inner cylinder, the direction of the jet forming the fiber bundles may be changed so that the jet is ejected irregularly.

For the enhanced splash spinning/electrospinning composite device, the outer diameter of the inner cylinder is 0.5-3 m, the inner diameter of the outer cylinder is 0.3-2.7 m, and the wall thickness of the inner cylinder or the outer cylinder is 0.1-0.3 m; the air supply device is used for providing airflow with a pressure of 2-30 MPa; the diameter of jet orifices is 0.4-1 mm, and the number of the jet orifices is 500-300.

For the enhanced splash spinning/electrospinning composite device, the inner cylinder of the first blowout device and the inner cylinder of the second blowout device are coaxial, a spacing between the vertical plate II of the first blowout device and the first nozzle being equal to a spacing between the vertical plate II of the second blowing device and the second nozzle, X being 30-60% of D.

For the enhanced flash-spinning/electrospinning composite device, the electrospinning device further includes a solvent atomizing generator for atomizing a liquid solvent; the second blowout device further includes a plurality of partition plates, which are parallel to the vertical plate I of the second blowout device, and the partition plates divide the seal chamber of the second blowout device into a plurality of sub-seal chambers with the same size; there are a plurality of air inlets on the outer cylinder of the second blowout device, with each sub-seal chamber connected to at least one air inlet, and an air quantity controller is mounted on the air inlet, so that the air quantity of the air inlet of each sub-seal chamber gradually increases along the jet advancing direction, and an air inlet pipe connected to the air inlet of each sub-seal chamber is simultaneously connected to the solvent atomizing generator; in the disclosure, the concentration of the solvent in the environment is controlled by controlling the air quantity to release different amounts of solvent in the spinning region, and the concentration of the solvent in the environment gradually increases along the jet advancing direction, so that the volatilization rate of the solvent may be slowed down, allowing a bonding state to form on the nanofibers, and when the nanofibers contact the flash-spun fibers, a bonding structure may be formed with the flash-spun fibers, and the bonding strength between the fibers after hot-pressing may be greatly increased.

For the enhanced flash-spinning/electrospinning composite device, the flash-spinning device further includes a polymer tank, a solvent tank and a high-temperature high-pressure reaction kettle, the polymer tank, the solvent tank and a flash-spinning spinneret unit being simultaneously connected to the high-temperature high-pressure reaction kettle.

For the enhanced flash-spinning/electrospinning composite device, the electrospinning device further includes an electrospinning reservoir connected to an electrospinning spinneret unit.

For the enhanced flash-spinning/electrospinning composite device, a spacing of 10-60 cm between the first nozzle or the second nozzle and the receiving conveyor belt is set to avoid being easily affected by airflow caused due to a too small spacing, which may lead to insufficient dispersion of the fibers in the air. This insufficient dispersion can reduce irregularity and affect the film forming strength. The spacing also avoids low production efficiency caused due to a too large spacing.

The enhanced flash-spinning/electrospinning composite device further includes a hot-pressing upper roller and a hot-pressing lower roller which are located on the upper side and the lower side of the receiving conveyor belt.

The principle of the disclosure is as follow:
in the process of preparing nanofibers by using an electrospinning process and preparing micron fibers by using a flash-spinning process, an electrospinning nozzle and a flash-spinning nozzle are controlled to be located at opposite positions, the fibers will immediately dry because the solvent is quickly volatilized in the process of instantaneously releasing pressure during flash-spinning, and single fibers are easily charged when there is an electrostatic field on the opposite side because the polymer is a non-conductive substance, and the charged single fibers are mutually repelled to form electrostatic repulsion. Therefore, the micron fibers prepared by flash-spinning exhibit various irregular distribution states under the action of the electrostatic force during electrospinning, forming entangled, curled and interpenetrated structures, and the nanofibers are uniformly interspersed and distributed within the micron fibers, some of the nanofibers and the micron fibers forming entangled and interpenetrated structures, to obtain the flash-spun/electrospun composite superfine nanofiber material.

On one hand, attachment sites, as well as entangled and interpenetrated structures, do not coincide with performance sites of coarse fibers prepared by single flash-spinning, so that a number of effective sites is greatly increased (improved by 20-50%), the greater the number of the effective sites, the higher the strength of the finally obtained fiber film is, and after high-temperature hot-pressing, strong bonding is generated between flash-spun coarse fibers, and meanwhile, an intricate network cross-bonding structure is formed between the electrospun nanofibers and between the nanofibers and the coarse fibers, so that the strength of the whole composite material is greatly improved.

Compared with the micron fibers prepared by the flash-spinning process, for the flash-spun/electrospun composite superfine nanofiber material, the entanglement degree between the fibers is greatly improved, and entanglements include horizontal entanglement and vertical entanglement, the more the horizontal entanglement is, the greater the strength is, the more the vertical entanglement is, the greater the cohesive number of the fibers before different layers is, the stronger the cohesive force is, the harder the fibers delaminate, which effectively solves the problem that the micron fibers prepared by the flash-spinning process are easy to delaminate.

On the other hand, compared with the micron fibers prepared by using the flash-spinning process, the flash-spun/electrospun composite superfine nanofiber material is added with a certain amount of nanofibers, or further the nanofibers include a water repellent, so that hydrophobic property of the nanofibers after hydrophobic modification is increased, and meanwhile, a small diameter structure among the nanofibers is beneficial to an increase of the water pressure resistance, and the porosity of the nanofibers is improved, so that the moisture permeability is greatly enhanced. Therefore, the flash-spun/electrospun composite superfine nanofiber material has excellent waterproof property and air permeability, which effectively solves the problem that the waterproof property and the air permeability of the micron fibers prepared by using the flash-spinning process are relatively low.

### Beneficial Effects

(1) The flash-spun/electrospun composite superfine nanofiber material in the disclosure substantially enhances the strength of the overall composite material while offering outstanding water pressure resistance and excellent moisture permeability, which provides a new solution for expanding and enhancing its performance in packaging and construction materials.

(2) The enhanced flash-spinning/electrospinning composite method in the disclosure improves entangled structures between fibers, bonding sites, fiber hydrophobicity and porosity, thereby significantly enhancing application performance of the material.

### BRIEF DESCRIPTION OF THE DRAWINGS

FIG. 1 is a schematic diagram illustrating an enhanced flash-spinning/electrospinning composite device in the disclosure; and

FIG. 2 is an expanded view illustrating an inner cylinder of a first blowout device in Embodiment 1, A representing a connecting end between the inner cylinder and a vertical plate I, and B representing a connecting end between the inner cylinder and a vertical plate II.

In the drawings, 1—polymer tank, 2—solvent tank, 3—high-temperature high-pressure reaction kettle, 4—first blowout device, 5—flash-spinning spinneret unit, 6—electrospinning spinneret unit, 7—electrospinning solution reservoir, 8—high-voltage power supply, 9—receiving conveyor belt, 10—hot-pressing upper roller, 11—hot-pressing lower roller, 12—second blowout device, 13—solvent atomizing generator, 14—ground wire.

### DETAILED DESCRIPTION OF PREFERRED EMBODIMENTS

The disclosure is further illustrated in combination with implementations. It should be noted that, these embodiments are only used to illustrate the disclosure rather than limit the scope of the disclosure. In addition, it shall be understood that after reading the contents taught in the present disclosure, those skilled in the art may make various changes or modifications to the disclosure, and these equivalent forms also fall within the scope defined by the appended claims of the disclosure.

A preparation method of a flash-spun/electrospun composite superfine nanofiber material is as follow:

In the process of preparing nanofibers by using an electrospinning process and preparing micron fibers by using a flash-spinning process, an electrospinning nozzle and a flash-spinning nozzle are controlled to be simultaneously located above a receiving conveyor belt directly opposite each other with a spacing of 15-40 cm, and meanwhile, the electrospinning nozzle is controlled to be connected to a high-voltage power supply, and the flash-spinning nozzle and the receiving conveyor belt are controlled to be grounded, to prepare the flash-spun/electrospun composite superfine nanofiber material.

An electrospinning solution includes polymer I and solvent I, the polymer I being polyethylene, polyvinylidene fluoride, polyacrylonitrile, polyurethane or polyvinyl butyal, the solvent I being DMF, DMAc, dichloromethane, 1H,6H-perfluorohexane, n-pentane or cyclopentane, and the concentration of the polymer I in the electrospinning solution being 2-40 wt %; the electrospinning solution further includes a water repellent, the water repellent being an organosilicon water repellent, a C6 water repellent or a C8 water repellent, and the concentration of the water repellent in the electrospinning solution being 0.5-5 wt %.

Electrospinning process parameters include a liquid flow rate of 1-10 mL/min, a spinning voltage of 30-100 kV, an ambient temperature of 23-25° C., and an ambient relative humidity of 20-90%.

The flash-spinning solution consists of 2-35 wt % of polymer II and a remainder of solvent II, the polymer II being polyethylene, with a melt index of 0.7 g/10 min at a temperature of 160° C. and under a load of 5 kg, and a melting point of 133° C., and the solvent II being dichloromethane, 1H,6H-perfluorohexane, n-pentane or cyclopentane.

Flash-spinning process parameters include a reaction pressure of 8-30 MPa, a reaction temperature of 150-300° C., and a stirring speed of 2500-1500 rpm.

Preferably, during electrospinning, irregular airflow blowing is applied to the jet ejected from the electrospinning nozzle; irregular airflow blowing is applied to the jet ejected from the flash-spinning nozzle.

Preferably, during electrospinning, the concentration of the solvent in an environment of a spinning region is controlled so that the concentration of the solvent in the environment gradually increases along the jet advancing direction.

Preferably, after electrospinning and flash-spinning, hot-pressing is performed on a whole consisting of the nanofibers and the micron fibers at a temperature between the melting point of the nanofibers and the melting point of the micron fibers for 0.2-0.7 min.

The flash-spun/electrospun composite superfine nanofiber material finally prepared as a whole has a film-like structure and consists of nanofibers and micron fibers. The micron fibers are mutually entangled, curled and interpenetrated, and the nanofibers are uniformly interspersed and distributed within the micron fibers, some of the nanofibers and the micron fibers forming entangled and interpenetrated structures, with mutual bonding between the nanofibers, between the micron fibers and between the nanofibers and the micron fibers, and the mass ratio of the nanofibers to the micron fibers being 1:5-2.5; an average diameter of the nanofibers is 50-800 nm, and an average diameter of the micron fibers is 1-20 km; the strength of the flash-spun/electrospun composite superfine nanofiber material is >100 N/50 mm, the porosity is >55%, the moisture permeability is >800 g/m² 24 h, and the water pressure resistance is >5 kPa.

The preparation method of the flash-spun/electrospun composite superfine nanofiber material may be implemented by various devices, and the specific devices used are not limited, as long as the preparation method is the same as above, and are within the protection scope of the present disclosure. One of the devices will be described exemplarily.

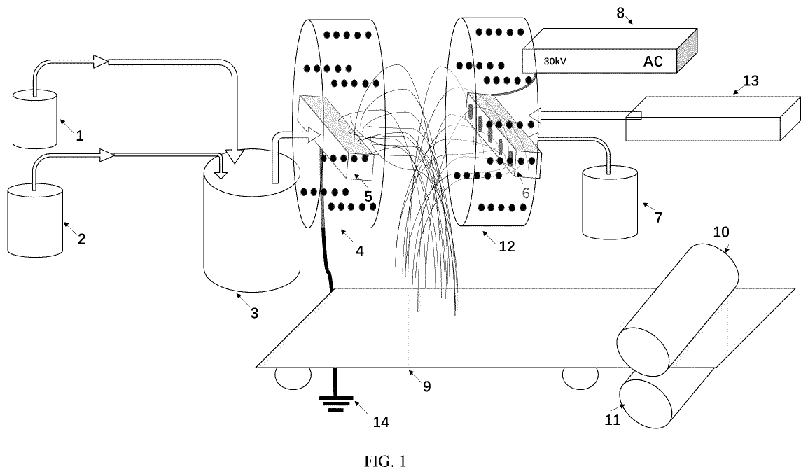

An enhanced flash-spinning/electrospinning composite device as shown in FIG. 1 includes a flash-spinning device, an electrospinning device and a grounded receiving conveyor belt 9.

The flash-spinning device further includes a flash-spinning spinneret unit 5, a polymer tank 1, a solvent tank 2 and a high-temperature high-pressure reaction kettle 3, the polymer tank 1, the solvent tank 2 and the flash-spinning spinneret unit 5 being simultaneously connected to the high-temperature high-pressure reaction kettle 3, and the flash-spinning spinneret unit 5 including a first nozzle grounded.

The electrospinning device includes a high-voltage power supply 8, an electrospinning spinneret unit 6 and an electrospinning reservoir 7 connected to the electrospinning spinneret unit 6. The electrospinning unit 6 includes a second nozzle, the second nozzle being connected to the high-voltage power supply 8.

The first nozzle and the second nozzle are controlled to be simultaneously located above the receiving conveyor belt 9 directly opposite each other with a spacing of D ranging 15-40 cm, and a spacing between the first nozzle or the second nozzle and the receiving conveyor belt 9 is 10-60 cm.

Preferably, the flash-spinning device further includes a first blowout device 4; the electrospinning device further includes a second blowout device 12. The first blowout device 4 or the second blowout device 12 includes an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the outer cylinder is provided with an air inlet, and the air inlet is connected to the air supply device outside the outer cylinder through an air inlet pipe; a plurality of jet orifices are irregularly distributed on the inner cylinder; a spacing between the vertical plate II of the first blowout device 4 and the vertical plate II of the second blowout device 12 is X, where X>0; the vertical plate I of the first blowout device 4 is fitted onto the first nozzle so that a jet from the first nozzle enters the inner cylinder of the first blowout device 4; the vertical plate I of the second blowout device 12 is fitted onto the second nozzle so that a jet from the second nozzle enters the inner cylinder of the second blowout device 12.

More preferably, the outer diameter of the inner cylinder is 0.5-3 m, the inner diameter of the outer cylinder is 0.3-2.7 m, and the wall thickness of the inner cylinder or the outer cylinder is 0.1-0.3 m; the air supply device is used for providing airflow with the pressure of 2-30 MPa; the diameter of the jet orifices is 0.4-1 mm, and the number of the jet orifices is 500-300.

More preferably, the inner cylinder of the first blowout device and the inner cylinder of the second blowout device are coaxial, and a spacing between the vertical plate II of the first blowout device 4 and the first nozzle is equal to a spacing between the vertical plate II of the second blowing device 12 and the second nozzle, X being 30-60% of D.

Preferably, the electrospinning device further includes a solvent atomizing generator 13 for atomizing a liquid solvent; the second blowout device 12 further includes a plurality of partition plates which are parallel to the vertical plate I of the second blowout device 12, and the partition plates divide the seal chamber of the second blowout device 12 into a plurality of sub-seal chambers with the same size; there are a plurality of air inlets on the outer cylinder of the second blowout device 12, each sub-seal chamber is connected to at least one air inlet, an air quantity controller is mounted on the air inlet, the air quantity of the air inlet of the each sub-seal chamber gradually increases along the jet advancing direction, and an air inlet pipe connected to the air inlet of the each sub-seal chamber is simultaneously connected to the solvent atomizing generator 13.

Preferably, the enhanced flash-spinning/electrospinning composite device further includes a hot-pressing upper roller 10 and a hot-pressing lower roller 11 which are located on the upper side and the lower side of the receiving conveyor belt 9.

The enhanced splash spinning/electrospinning composite device and the process of preparing the flash-spun/electrospun composite superfine nanofiber material by using the enhanced splash spinning/electrospinning composite device are illustrated in combination with embodiments.

### Embodiment 1

An enhanced flash-spinning/electrospinning composite device as shown in FIG. 1 includes a flash-spinning device, an electrospinning device and a receiving conveyor belt 9 connected to a ground wire 14 and a hot-pressing upper roller 10 and a hot-pressing lower roller 11 on the upper side and the lower side of the receiving conveyor belt 9.

The flash-spinning device further includes a flash-spinning spinneret unit 5, a first blowout device 4, a polymer tank 1, a solvent tank 2 and a high-temperature high-pressure reaction kettle 3, the polymer tank 1, the solvent tank 2 and the flash-spinning spinneret unit 5 being simultaneously connected to the high-temperature high-pressure reaction kettle 3.

The flash-spinning spinneret unit 5 includes a first nozzle connected to the ground wire 14.

The electrospinning device includes a high-voltage power supply 8, a second blowout device 12, an electrospinning spinneret unit 6, a solvent atomizing generator for atomizing a liquid solvent and an electrospinning reservoir 7 connected to the electrospinning spinneret unit 6.

The flash-spinning spinneret unit 6 includes a second nozzle connected to the high-voltage power supply 8.

The first nozzle and the second nozzle are simultaneously located above a receiving conveyor belt 9, and are directly opposite each other with a spacing of D, D being 15 cm; a spacing between the first nozzle and the receiving conveyor belt 9 is 10 cm; a spacing between the second nozzle and the receiving conveyor belt 9 is 10 cm.

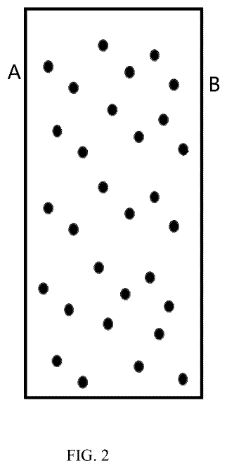

The first blowout device 4 includes an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the outer cylinder is provided with an air inlet, and the air inlet is connected to the air supply device outside the outer cylinder through an air inlet pipe; as shown in FIG. 2 (FIG. 2 is only schematic, and does not completely show all jet orifices), 300 jet orifices with a diameter of 0.4 mm are irregularly distributed on the inner cylinder.

For the first blowout device, the outer diameter of the inner cylinder is 0.5 m, the inner diameter of the outer cylinder is 0.3 m, the wall thickness of the inner cylinder is 0.1 m, and the wall thickness of the outer cylinder is 0.13 m; the air supply device is used for providing airflow with the pressure of 2 MPa.

The vertical plate I of the first blowout device 4 is fitted onto the first nozzle so that a jet from the first nozzle enters the inner cylinder of the first blowout device 4.

The second blowout device 12 includes 4 partition plates, an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the partition plates are parallel to the vertical plate I, and the seal chamber is divided into 5 sub-seal chambers with the same size by the plurality of partition plates; the outer cylinder is provided with 5 air inlets, and the air inlets are connected to the air supply device outside the outer cylinder through an air inlet pipe; each sub-seal chamber is connected to one air inlet, and an air quantity controller is mounted on the air inlet, the air quantity of the air inlet of each sub-seal chamber gradually increasing along the jet advancing direction, and an air inlet pipe connected to the air inlet of each sub-seal chamber is simultaneously connected to a solvent atomizing generator 13 (i.e. the air inlet pipe is simultaneously connected to the air supply device and the solvent atomizing generator); 300 jet orifices with a diameter of 0.4 mm are irregularly distributed on the inner cylinder.

For the second blowout device, the outer diameter of the inner cylinder is 0.5 m, the inner diameter of the outer cylinder is 0.3 m, the wall thickness of the inner cylinder is 0.1 m, and the wall thickness of the outer cylinder is 0.1 m; the air supply device is used for providing airflow with the pressure of 2 MPa.

The vertical plate I of the second blowout device 12 is fitted onto the second nozzle so that a jet from the second nozzle enters the inner cylinder of the second blowout device 12.

The inner cylinder of the first blowout device 4 and the inner cylinder of the second blowout device 12 are coaxial, a spacing between the vertical plate II of the first blowout device 4 and the first nozzle is equal to a spacing between the vertical plate II of the second blowing device 12 and the second nozzle, and a spacing between the vertical plate II of the first blowout device and the vertical plate II of the second blowout device is X, X being 30% of D.

In the preparation method of the flash-spun/electrospun composite superfine nanofiber material, the enhanced flash-spinning/electrospinning composite device is used. The following preparations are made before the device is started:
an electrospinning solution is injected into an electrospinning reservoir, the electrospinning solution including polyethylene, an organosilicon water repellent (Akzo Nobel SEAL 80), and DMF; the concentration of polyethylene in the electrospinning solution being 2 wt %; the concentration of the organosilicon water repellent (Akzo Nobel SEAL 80) in the electrospinning solution being 0.5 wt %;
parameters of the electrospinning device are set, so that the electrospinning process parameters include a liquid flow rate of 1 mL/min, a spinning voltage of 30 kV, an ambient temperature of 23° C., and an ambient relative humidity of 90%;
DMF is injected into a solvent atomizing generator;
parameters of the air volume controller are set, so that air quantities of air inlets of the sub-seal chambers along the jet advancing direction are 10 m³/h, 18 m³/h, 32 m³/h, 36 m³/h and 40 m³/h, respectively;
a certain amount of polymer is put into the polymer tank, and a certain amount of solvent is put into the solvent tank; the type and the addition amount of the polymer and the type and the addition amount of the solvent need to meet the following conditions: after the device is started, a flash-spinning solution is formed in a high-temperature and high-pressure reaction kettle, the flash-spinning solution consisting of 2 wt % of polyethylene and a remainder of dichloromethane; the melt index of polyethylene in the flash-spinning solution at a temperature of 160° C. and under a load of 5 kg is 0.7 g/10 min, and the melting point of polyethylene is 133° C.;
parameters of the flash-spinning device are set, so that the flash-spinning process parameters include a reaction pressure of 8 MPa, a reaction temperature of 300° C., and a stirring speed of 500 rpm;
parameters of the hot-pressing upper roller and the hot-pressing lower roller are set, so that hot-pressing is performed on a whole consisting of nanofibers and micron fibers at a temperature of 100° C. for 0.2 min;
after the above preparations are made, the device is started, to prepare the flash-spun/electrospun composite superfine nanofiber material.

The flash-spun/electrospun composite superfine nanofiber material prepared as a whole has a film-like structure and consists of nanofibers having an average diameter of 80 nm and micron fibers having an average diameter of 1.2 m. The micron fibers are mutually entangled, curled and interpenetrated, and the nanofibers are uniformly interspersed and distributed within the micron fibers, some of the nanofibers and the micron fibers forming entangled and interpenetrated structures, with mutual bonding between the nanofibers, between the micron fibers and between the nanofibers and the micron fibers, and the mass ratio of the nanofibers to the micron fibers being 11:50; the strength of the flash-spun/electrospun composite superfine nanofiber material is 450 N/50 mm, the porosity is 83%, the moisture permeability is 1600 g/m² 24 h, and the water pressure resistance is 45 kPa.

### Embodiment 2

An enhanced flash-spinning/electrospinning composite device includes a flash-spinning device, an electrospinning device, a grounded receiving conveyor belt, and a hot-pressing upper roller and a hot-pressing lower roller on the upper side and the lower side of the receiving conveyor belt.

The flash-spinning device further includes a flash-spinning spinneret unit, a first blowout device, a polymer tank, a solvent tank and a high-temperature high-pressure reaction kettle, the polymer tank, the solvent tank and the flash-spinning spinneret unit being simultaneously connected to the high-temperature high-pressure reaction kettle.

The flash-spinning spinneret unit includes a grounded first nozzle.

The electrospinning device includes a high-voltage power supply, a second blowout device, an electrospinning spinneret unit, a solvent atomizing generator for atomizing a liquid solvent and an electrospinning reservoir connected to the electrospinning spinneret unit.

The flash-spinning spinneret unit includes a second nozzle connected to the high-voltage power supply.

The first nozzle and the second nozzle are simultaneously located above the receiving conveyor belt, and are directly opposite each other with a spacing of D, D being 18 cm; a spacing between the first nozzle and the receiving conveyor belt is 20 cm; a spacing between the second nozzle and the receiving conveyor belt is 20 cm.

The first blowout device includes an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the outer cylinder is provided with an air inlet, and the air inlet is connected to the air supply device outside the outer cylinder through an air inlet pipe; 350 jet orifices with a diameter of 0.5 mm are irregularly distributed on the inner cylinder.

For the first blowout device, the outer diameter of the inner cylinder is 1 m, the inner diameter of the outer cylinder is 0.7 m, the wall thickness of the inner cylinder is 0.15 m, and the wall thickness of the outer cylinder is 0.18 m; the air supply device is used for providing airflow with a pressure of 5 MPa.

The vertical plate I of the first blowout device is fitted onto the first nozzle, so that a jet from the first nozzle enters the inner cylinder of the first blowout device.

The second blowout device includes 4 partition plates, an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the partition plates are parallel to the vertical plate I, and the seal chamber is divided into 5 sub-seal chambers with the same size by the plurality of partition plates; the outer cylinder is provided with 5 air inlets, and the air inlets are connected to the air supply device outside the outer cylinder through an air inlet pipe; each sub-seal chamber is connected to one air inlet, and an air quantity controller is mounted on the air inlet, the air quantity of the air inlet of each sub-seal chamber gradually increasing along the jet advancing direction, and an air inlet pipe connected to the air inlet of each sub-seal chamber is simultaneously connected to a solvent atomizing generator (i.e. the air inlet pipe is simultaneously connected to the air supply device and the solvent atomizing generator); 380 jet orifices with a diameter of 0.52 mm are irregularly distributed on the inner cylinder.

For the second blowout device, the outer diameter of the inner cylinder is 1 m, the inner diameter of the outer cylinder is 0.8 m, the wall thickness of the inner cylinder is 0.12 m, and the wall thickness of the outer cylinder is 0.12 m; the air supply device is used for providing airflow with the pressure of 7.8 MPa.

The vertical plate I of the second blowout device is fitted onto the second nozzle so that a jet from the second nozzle enters the inner cylinder of the second blowout device.

The inner cylinder of the first blowout device and the inner cylinder of the second blowout device are coaxial, a spacing between the vertical plate II of the first blowout device and the first nozzle is equal to a spacing between the vertical plate II of the second blowing device and the second nozzle, and a spacing between the vertical plate II of the first blowout device and the vertical plate II of the second blowout device is X, X being 38% of D.

In the preparation method of the flash-spun/electrospun composite superfine nanofiber material, the enhanced flash-spinning/electrospinning composite device is used. The following preparations are made before the device is started:

An electrospinning solution is injected into an electrospinning reservoir, the electrospinning solution including polyvinylidene fluoride, a C6 water repellent (KES Z-2001), and DMAc; the concentration of polyvinylidene fluoride in the electrospinning solution being 4 wt %; the concentration of the C6 water repellent (KES Z-2001) in the electrospinning solution being 1 wt %.

Parameters of the electrospinning device are set, so that the electrospinning process parameters include a liquid flow rate of 2 mL/min, a spinning voltage of 40 kV, an ambient temperature of 23° C., and an ambient relative humidity of 80%.

DMAc is injected into a solvent atomizing generator.

Parameters of the air volume controller are set, so that air quantities of air inlets of the sub-seal chambers along the jet advancing direction are 12 m³/h, 20 m³/h, 34 m³/h, 38 m³/h and 44 m³/h, respectively.

A certain amount of polymer is put into the polymer tank, and a certain amount of solvent is put into the solvent tank; the type and the addition amount of the polymer and the type and the addition amount of the solvent need to meet the following conditions: after the device is started, a flash-spinning solution is formed in a high-temperature and high-pressure reaction kettle, the flash-spinning solution consisting of 6 wt % of polyethylene and a remainder of 1H,6H-perfluorohexane; the melt index of polyethylene in the flash-spinning solution at a temperature of 160° C. and under a load of 5 kg is 0.7 g/10 min, and the melting point of polyethylene is 133° C.

Parameters of the flash-spinning device are set, so that the flash-spinning process parameters include a reaction pressure of 13 MPa, a reaction temperature of 270° C., and a stirring speed of 700 rpm.

Parameters of the hot-pressing upper roller and the hot-pressing lower roller are set, so that hot-pressing is performed on a whole consisting of nanofibers and micron fibers at a temperature of 130° C. for 0.3 min.

After the above preparations are made, the device is started, to prepare the flash-spun/electrospun composite superfine nanofiber material.

The flash-spun/electrospun composite superfine nanofiber material prepared as a whole has a film-like structure and consists of nanofibers having an average diameter of 150 nm and micron fibers having an average diameter of 3 m. The micron fibers are mutually entangled, curled and interpenetrated, and the nanofibers are uniformly interspersed and distributed within the micron fibers, some of the nanofibers and the micron fibers forming entangled and interpenetrated structures, with mutual bonding between the nanofibers, between the micron fibers and between the nanofibers and the micron fibers, and the mass ratio of the nanofibers to the micron fibers being 1:4; the strength of the flash-spun/electrospun composite superfine nanofiber material is 480 N/50 mm, the porosity is 85%, the moisture permeability is 1980 g/m² 24 h, and the water pressure resistance is 40 kPa.

### Embodiment 3

An enhanced flash-spinning/electrospinning composite device includes a flash-spinning device, an electrospinning device, a grounded receiving conveyor belt, and a hot-pressing upper roller and a hot-pressing lower roller on the upper side and the lower side of the receiving conveyor belt.

The flash-spinning device further includes a flash-spinning spinneret unit, a first blowout device, a polymer tank, a solvent tank and a high-temperature high-pressure reaction kettle, the polymer tank, the solvent tank and the flash-spinning spinneret unit being simultaneously connected to the high-temperature high-pressure reaction kettle.

The flash-spinning spinneret unit includes a grounded first nozzle.

The electrospinning device includes a high-voltage power supply, a second blowout device, an electrospinning spinneret unit, a solvent atomizing generator for atomizing a liquid solvent and an electrospinning reservoir connected to the electrospinning spinneret unit.

The flash-spinning spinneret unit includes a second nozzle connected to the high-voltage power supply.

The first nozzle and the second nozzle are simultaneously located above the receiving conveyor belt, and are directly opposite each other with a spacing of D, D being 22 cm; a spacing between the first nozzle and the receiving conveyor belt is 30 cm; a spacing between the second nozzle and the receiving conveyor belt is 30 cm.

The first blowout device includes an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the outer cylinder is provided with an air inlet, and the air inlet is connected to the air supply device outside the outer cylinder through an air inlet pipe; 400 jet orifices with a diameter of 0.6 mm are irregularly distributed on the inner cylinder.

For the first blowout device, the outer diameter of the inner cylinder is 1.5 m, the inner diameter of the outer cylinder is 1.2 m, the wall thickness of the inner cylinder is 0.2 m, and the wall thickness of the outer cylinder is 0.2 m; the air supply device is used for providing airflow with a pressure of 10 MPa.

The vertical plate I of the first blowout device is fitted onto the first nozzle, so that a jet from the first nozzle enters the inner cylinder of the first blowout device.

The second blowout device includes 5 partition plates, an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the partition plates are parallel to the vertical plate I, and the seal chamber is divided into 6 sub-seal chambers with the same size by the plurality of partition plates; the outer cylinder is provided with 6 air inlets, and the air inlets are connected to the air supply device outside the outer cylinder through an air inlet pipe; each sub-seal chamber is connected to one air inlet, and an air quantity controller is mounted on the air inlet, the air quantity of the air inlet of each sub-seal chamber gradually increasing along the jet advancing direction, and an air inlet pipe connected to the air inlet of each sub-seal chamber is simultaneously connected to a solvent atomizing generator (i.e. the air inlet pipe is simultaneously connected to the air supply device and the solvent atomizing generator); 410 jet orifices with a diameter of 0.63 mm are irregularly distributed on the inner cylinder.

For the second blowout device, the outer diameter of the inner cylinder is 1.5 m, the inner diameter of the outer cylinder is 1.4 m, the wall thickness of the inner cylinder is 0.18 m, and the wall thickness of the outer cylinder is 0.18 m; the air supply device is used for providing airflow with the pressure of 12.9 MPa.

The vertical plate I of the second blowout device is fitted onto the second nozzle so that a jet from the second nozzle enters the inner cylinder of the second blowout device.

The inner cylinder of the first blowout device and the inner cylinder of the second blowout device are coaxial, a spacing between the vertical plate II of the first blowout device and the first nozzle is equal to a spacing between the vertical plate II of the second blowing device and the second nozzle, and a spacing between the vertical plate II of the first blowout device and the vertical plate II of the second blowout device is X, X being 46% of D.

In the preparation method of the flash-spun/electrospun composite superfine nanofiber material, the enhanced flash-spinning/electrospinning composite device is used. The following preparations are made before the device is started:

An electrospinning solution is injected into an electrospinning reservoir, the electrospinning solution including polyacrylonitrile, a C8 water repellent (DAIKIN 5003F), and dichloromethane; the concentration of polyacrylonitrile in the electrospinning solution being 10 wt %; the concentration of the C8 water repellent (DAIKIN 5003F) in the electrospinning solution being 3 wt %;
parameters of the electrospinning device are set, so that the electrospinning process parameters include a liquid flow rate of 4 mL/min, a spinning voltage of 50 kV, an ambient temperature of 24° C., and an ambient relative humidity of 70%.

Dichloromethane is injected into a solvent atomizing generator.

Parameters of the air volume controller are set, so that air quantities of air inlets of the sub-seal chambers along the jet advancing direction are 10 m³/h, 18 m³/h, 32 m³/h, 36 m³/h, 40 m³/h and 46 m³/h, respectively.

A certain amount of polymer is put into the polymer tank, a certain amount of solvent is put into the solvent tank, and the type and the addition amount of the polymer and the type and the addition amount of the solvent need to meet the following conditions: after the device is started, a flash-spinning solution is formed in a high-temperature and high-pressure reaction kettle, the flash-spinning solution consisting of 10 wt % of polyethylene and a remainder of n-pentane; the melt index of polyethylene in the flash-spinning solution at a temperature of 160° C. and under a load of 5 kg is 0.7 g/10 min, and the melting point of polyethylene is 133° C.

Parameters of the flash-spinning device are set, so that the flash-spinning process parameters include a reaction pressure of 16 MPa, a reaction temperature of 230° C., and a stirring speed of 900 rpm.

Parameters of the hot-pressing upper roller and the hot-pressing lower roller are set, so that hot-pressing is performed on a whole consisting of nanofibers and micron fibers at a temperature of 180° C. for 0.4 min.

After the above preparations are made, the device is started, to prepare the flash-spun/electrospun composite superfine nanofiber material.

The flash-spun/electrospun composite superfine nanofiber material prepared as a whole has a film-like structure and consists of nanofibers having an average diameter of 230 nm and micron fibers having an average diameter of 6 m. The micron fibers are mutually entangled, curled and interpenetrated, and the nanofibers are uniformly interspersed and distributed within the micron fibers, some of the nanofibers and the micron fibers forming entangled and interpenetrated structures, with mutual bonding between the nanofibers, between the micron fibers and between the nanofibers and the micron fibers, and the mass ratio of the nanofibers to the micron fibers being 3:10; the strength of the flash-spun/electrospun composite superfine nanofiber material is 500 N/50 mm, the porosity is 88%, the moisture permeability is 2500 g/m² 24 h, and the water pressure resistance is 36 kPa.

### Embodiment 4

An enhanced flash-spinning/electrospinning composite device includes a flash-spinning device, an electrospinning device, a grounded receiving conveyor belt, and a hot-pressing upper roller and a hot-pressing lower roller on the upper side and the lower side of the receiving conveyor belt.

The flash-spinning device further includes a flash-spinning spinneret unit, a first blowout device, a polymer tank, a solvent tank and a high-temperature high-pressure reaction kettle, the polymer tank, the solvent tank and the flash-spinning spinneret unit being simultaneously connected to the high-temperature high-pressure reaction kettle.

The flash-spinning spinneret unit includes a grounded first nozzle.

The electrospinning device includes a high-voltage power supply, a second blowout device, an electrospinning spinneret unit, a solvent atomizing generator for atomizing a liquid solvent and an electrospinning reservoir connected to the electrospinning spinneret unit.

The flash-spinning spinneret unit includes a second nozzle connected to the high-voltage power supply.

The first nozzle and the second nozzle are simultaneously located above the receiving conveyor belt, and are directly opposite each other with a spacing of D, D being 26 cm; a spacing between the first nozzle and the receiving conveyor belt is 40 cm; a spacing between the second nozzle and the receiving conveyor belt is 40 cm.

The first blowout device includes an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the outer cylinder is provided with an air inlet, and the air inlet is connected to the air supply device outside the outer cylinder through an air inlet pipe; 450 jet orifices with a diameter of 0.7 mm are irregularly distributed on the inner cylinder.

For the first blowout device, the outer diameter of the inner cylinder is 2 m, the inner diameter of the outer cylinder is 1.6 m, the wall thickness of the inner cylinder is 0.22 m, and the wall thickness of the outer cylinder is 0.23 m; the air supply device is used for providing airflow with a pressure of 15 MPa.

The vertical plate I of the first blowout device is fitted onto the first nozzle, so that a jet from the first nozzle enters the inner cylinder of the first blowout device.

The second blowout device includes 6 partition plates, an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the partition plates are parallel to the vertical plate I, and the seal chamber is divided into 7 sub-seal chambers with the same size by the plurality of partition plates; the outer cylinder is provided with 7 air inlets, and the air inlets are connected to the air supply device outside the outer cylinder through an air inlet pipe; each sub-seal chamber is connected to one air inlet, and an air quantity controller is mounted on the air inlet, the air quantity of the air inlet of each sub-seal chamber gradually increasing along the jet advancing direction, and an air inlet pipe connected to the air inlet of each sub-seal chamber is simultaneously connected to a solvent atomizing generator (i.e. the air inlet pipe is simultaneously connected to the air supply device and the solvent atomizing generator); 440 jet orifices with a diameter of 0.75 mm are irregularly distributed on the inner cylinder.

For the second blowout device, the outer diameter of the inner cylinder is 2 m, the inner diameter of the outer cylinder is 1.9 m, the wall thickness of the inner cylinder is 0.2 m, and the wall thickness of the outer cylinder is 0.2 m; the air supply device is used for providing airflow with the pressure of 19 MPa.

The vertical plate I of the second blowout device is fitted onto the second nozzle so that a jet from the second nozzle enters the inner cylinder of the second blowout device.

The inner cylinder of the first blowout device and the inner cylinder of the second blowout device are coaxial, a spacing between the vertical plate II of the first blowout device and the first nozzle is equal to a spacing between the vertical plate II of the second blowing device and the second nozzle, and a spacing between the vertical plate II of the first blowout device and the vertical plate II of the second blowout device is X, X being 51% of D.

In the preparation method of the flash-spun/electrospun composite superfine nanofiber material, the enhanced flash-spinning/electrospinning composite device is used. The following preparations are made before the device is started:

An electrospinning solution is injected into an electrospinning reservoir, the electrospinning solution including polyurethane, a C8 water repellent (DAIKIN 5003F), and 1H,6H-perfluorohexane; the concentration of polyurethane in the electrospinning solution being 20 wt %; the concentration of the C8 water repellent (DAIKIN 5003F) in the electrospinning solution being 5 wt %.

Parameters of the electrospinning device are set, so that the electrospinning process parameters include a liquid flow rate of 6 mL/min, a spinning voltage of 70 kV, an ambient temperature of 24° C., and an ambient relative humidity of 50%.

1H,6H-perfluorohexane is injected into a solvent atomizing generator.

Parameters of the air quantity controller are set, so that air quantities of air inlets of the sub-seal chambers along the jet advancing direction are 14 m³/h, 17 m³/h, 28 m³/h, 33 m³/h, 38 m³/h, 43 m³/h and 50 m³/h, respectively.

A certain amount of polymer is put into the polymer tank, and a certain amount of solvent is put into the solvent tank; the type and the addition amount of the polymer and the type and the addition amount of the solvent need to meet the following conditions: after the device is started, a flash-spinning solution is formed in a high-temperature and high-pressure reaction kettle, the flash-spinning solution consisting of 15 wt % of polyethylene and a remainder of cyclopentane; the melt index of polyethylene in the flash-spinning solution at a temperature of 160° C. and under a load of 5 kg being 0.7 g/10 min, and the melting point of polyethylene being 133° C.

Parameters of the flash-spinning device are set, so that the flash-spinning process parameters include a reaction pressure of 19 MPa, a reaction temperature of 200° C., and a stirring speed of 1100 rpm.

Parameters of the hot-pressing upper roller and the hot-pressing lower roller are set, so that hot-pressing is performed on a whole consisting of nanofibers and micron fibers at a temperature of 90° C. for 0.5 min.

After the above preparations are made, the device is started, to prepare the flash-spun/electrospun composite superfine nanofiber material.

The flash-spun/electrospun composite superfine nanofiber material prepared as a whole has a film-like structure and consists of nanofibers having an average diameter of 300 nm and micron fibers having an average diameter of 12 m. The micron fibers are mutually entangled, curled and interpenetrated, and the nanofibers are uniformly interspersed and distributed within the micron fibers, some of the nanofibers and the micron fibers forming entangled and interpenetrated structures, with mutual bonding between the nanofibers, between the micron fibers and between the nanofibers and the micron fibers, and the mass ratio of the nanofibers to the micron fibers being 33:100; the strength of the flash-spun/electrospun composite superfine nanofiber material is 510 N/50 mm, the porosity is 91%, the moisture permeability is 3600 g/m² 24 h, and the water pressure resistance is 34 kPa.

### Embodiment 5

An enhanced flash-spinning/electrospinning composite device includes a flash-spinning device, an electrospinning device, a grounded receiving conveyor belt, and a hot-pressing upper roller and a hot-pressing lower roller on the upper side and the lower side of the receiving conveyor belt.

The flash-spinning device further includes a flash-spinning spinneret unit, a first blowout device, a polymer tank, a solvent tank and a high-temperature high-pressure reaction kettle, the polymer tank, the solvent tank and the flash-spinning spinneret unit being simultaneously connected to the high-temperature high-pressure reaction kettle.

The flash-spinning spinneret unit includes a grounded first nozzle.

The electrospinning device includes a high-voltage power supply, a second blowout device, an electrospinning spinneret unit, a solvent atomizing generator for atomizing a liquid solvent and an electrospinning reservoir connected to the electrospinning spinneret unit.

The flash-spinning spinneret unit includes a second nozzle connected to the high-voltage power supply.

The first nozzle and the second nozzle are simultaneously located above the receiving conveyor belt, and are directly opposite each other with a spacing of D, D being 32 cm; a spacing between the first nozzle and the receiving conveyor belt is 50 cm; a spacing between the second nozzle and the receiving conveyor belt is 50 cm.

The first blowout device includes an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the outer cylinder is provided with an air inlet, and the air inlet is connected to the air supply device outside the outer cylinder through an air inlet pipe; 470 jet orifices with a diameter of 0.9 mm are irregularly distributed on the inner cylinder.

For the first blowout device, the outer diameter of the inner cylinder is 2.5 m, the inner diameter of the outer cylinder is 2.3 m, the wall thickness of the inner cylinder is 0.25 m, and the wall thickness of the outer cylinder is 0.27 m; the air supply device is used for providing airflow with a pressure of 20 MPa.

The vertical plate I of the first blowout device is fitted onto the first nozzle, so that a jet from the first nozzle enters the inner cylinder of the first blowout device.

The second blowout device includes 7 partition plates, an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the partition plates are parallel to the vertical plate I, and the seal chamber is divided into 8 sub-seal chambers with the same size by the plurality of partition plates; the outer cylinder is provided with 8 air inlets, and the air inlets are connected to the air supply device outside the outer cylinder through an air inlet pipe; each sub-seal chamber is connected to one air inlet, and an air quantity controller is mounted on the air inlet, the air quantity of the air inlet of each sub-seal chamber gradually increasing along the jet advancing direction, and an air inlet pipe connected to the air inlet of each sub-seal chamber is simultaneously connected to a solvent atomizing generator (i.e. the air inlet pipe is simultaneously connected to the air supply device and the solvent atomizing generator); 460 jet orifices with a diameter of 0.88 mm are irregularly distributed on the inner cylinder.

For the second blowout device, the outer diameter of the inner cylinder is 2.5 m, the inner diameter of the outer cylinder is 2.3 m, the wall thickness of the inner cylinder is 0.23 m, and the wall thickness of the outer cylinder is 0.23 m; the air supply device is used for providing airflow with a pressure of 25.9 MPa.

The vertical plate I of the second blowout device is fitted onto the second nozzle so that a jet from the second nozzle enters the inner cylinder of the second blowout device.

The inner cylinder of the first blowout device and the inner cylinder of the second blowout device are coaxial, a spacing between the vertical plate II of the first blowout device and the first nozzle is equal to a spacing between the vertical plate II of the second blowing device and the second nozzle, and a spacing between the vertical plate II of the first blowout device and the vertical plate II of the second blowout device is X, X being 54% of D.

In the preparation method of the flash-spun/electrospun composite superfine nanofiber material, the enhanced flash-spinning/electrospinning composite device is used. The following preparations are made before the device is started:

An electrospinning solution is injected into an electrospinning reservoir, the electrospinning solution including polyvinyl butyal and n-pentane; the concentration of polyvinyl butyal in the electrospinning solution being 30 wt %.

Parameters of the electrospinning device are set, so that the electrospinning process parameters include a liquid flow rate of 8 mL/min, a spinning voltage of 80 kV, an ambient temperature of 25° C., and an ambient relative humidity of 35%.

N-pentane is injected into a solvent atomizing generator.

Parameters of the air quantity controller are set, so that air quantities of air inlets of sub-seal chambers along the jet advancing direction are 6 m³/h, 12 m³/h, 18 m³/h, 27 m³/h, 34 m³/h, 36 m³/h, 39 m³/h and 45 m³/h, respectively;

A certain amount of polymer is put into the polymer tank, and a certain amount of solvent is put into the solvent tank; the type and the addition amount of the polymer and the type and the addition amount of the solvent need to meet the following conditions: after the device is started, a flash-spinning solution is formed in a high-temperature and high-pressure reaction kettle, the flash-spinning solution consisting of 27 wt % of polyethylene and a remainder of dichloromethane; the melt index of polyethylene in the flash-spinning solution at a temperature of 160° C. and under a load of 5 kg is 0.7 g/10 min, and the melting point of polyethylene is 133° C.

Parameters of the flash-spinning device are set, so that the flash-spinning process parameters include a reaction pressure of 25 MPa, a reaction temperature of 180° C., and a stirring speed of 1300 rpm.

Parameters of the hot-pressing upper roller and the hot-pressing lower roller are set, so that hot-pressing is performed on a whole consisting of nanofibers and micron fibers at a temperature of 110° C. for 0.6 min.

After the above preparations are made, the device is started, to prepare the flash-spun/electrospun composite superfine nanofiber material.

The flash-spun/electrospun composite superfine nanofiber material prepared as a whole has a film-like structure and consists of nanofibers having an average diameter of 580 nm and micron fibers having an average diameter of 16 m. The micron fibers are mutually entangled, curled and interpenetrated, and the nanofibers are uniformly interspersed and distributed within the micron fibers, some of the nanofibers and the micron fibers forming entangled and interpenetrated structures, with mutual bonding between the nanofibers, between the micron fibers and between the nanofibers and the micron fibers, and the mass ratio of the nanofibers to the micron fibers being 7:20; the strength of the flash-spun/electrospun composite superfine nanofiber material is 550 N/50 mm, the porosity is 91%, the moisture permeability is 4200 g/m² 24 h, and the water pressure resistance is 26 kPa.

### Embodiment 6

An enhanced flash-spinning/electrospinning composite device includes a flash-spinning device, an electrospinning device, a grounded receiving conveyor belt, and a hot-pressing upper roller and a hot-pressing lower roller on the upper side and the lower side of the receiving conveyor belt.

The flash-spinning device further includes a flash-spinning spinneret unit, a first blowout device, a polymer tank, a solvent tank and a high-temperature high-pressure reaction kettle, the polymer tank, the solvent tank and the flash-spinning spinneret unit being simultaneously connected to the high-temperature high-pressure reaction kettle.

The flash-spinning spinneret unit includes a grounded first nozzle.

The electrospinning device includes a high-voltage power supply, a second blowout device, an electrospinning spinneret unit, a solvent atomizing generator for atomizing a liquid solvent and an electrospinning reservoir connected to the electrospinning spinneret unit.

The flash-spinning spinneret unit includes a second nozzle connected to the high-voltage power supply.

The first nozzle and the second nozzle are simultaneously located above the receiving conveyor belt, and are directly opposite each other with a spacing of D, D being 40 cm; a spacing between the first nozzle and the receiving conveyor belt is 60 cm; a spacing between the second nozzle and the receiving conveyor belt is 60 cm.

The first blowout device includes an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the outer cylinder is provided with an air inlet, and the air inlet is connected to the air supply device outside the outer cylinder through an air inlet pipe; 500 jet orifices with a diameter of 1 mm are irregularly distributed on the inner cylinder.

For the first blowout device, the outer diameter of the inner cylinder is 3 m, the inner diameter of the outer cylinder is 2.7 m, the wall thickness of the inner cylinder is 0.3 m, and the wall thickness of the outer cylinder is 0.3 m; the air supply device is used for providing airflow with a pressure of 30 MPa.

The vertical plate I of the first blowout device is fitted onto the first nozzle, so that a jet from the first nozzle enters the inner cylinder of the first blowout device.

The second blowout device includes 8 partition plates, an air supply device, an inner cylinder, an outer cylinder, a vertical plate I and a vertical plate II; the outer cylinder is fitted onto the inner cylinder, and the outer cylinder and the inner cylinder are coaxial and flush at two ends, one of which is sealed by the vertical plate I, and the other of which is connected by the vertical plate II; the inner cylinder, the outer cylinder, the vertical plate I and the vertical plate II jointly enclose a seal chamber; the partition plates are parallel to the vertical plate I, and the seal chamber is divided into 9 sub-seal chambers with the same size by the plurality of partition plates; the outer cylinder is provided with 9 air inlets, and the air inlets are connected to the air supply device outside the outer cylinder through an air inlet pipe; each sub-seal chamber is connected to one air inlet, and an air quantity controller is mounted on the air inlet, the air quantity of the air inlet of each sub-seal chamber gradually increasing along the jet advancing direction, and an air inlet pipe connected to the air inlet of each sub-seal chamber is simultaneously connected to a solvent atomizing generator (i.e. the air inlet pipe is simultaneously connected to the air supply device and the solvent atomizing generator); 500 jet orifices with a diameter of 1 mm are irregularly distributed on the inner cylinder.

For the second blowout device, the outer diameter of the inner cylinder is 3 m, the inner diameter of the outer cylinder is 2.7 m, the wall thickness of the inner cylinder is 0.3 m, and the wall thickness of the outer cylinder is 0.3 m; the air supply device is used for providing airflow with the pressure of 30 MPa.

The vertical plate I of the second blowout device is fitted onto the second nozzle so that a jet from the second nozzle enters the inner cylinder of the second blowout device.

The inner cylinder of the first blowout device and the inner cylinder of the second blowout device are coaxial, a spacing between the vertical plate II of the first blowout device and the first nozzle is equal to a spacing between the vertical plate II of the second blowing device and the second nozzle, and a spacing between the vertical plate II of the first blowout device and the vertical plate II of the second blowout device is X, X being 59% of D.

In the preparation method of the flash-spun/electrospun composite superfine nanofiber material, the enhanced flash-spinning/electrospinning composite device is used. The following preparations are made before the device is started:

An electrospinning solution is injected into an electrospinning reservoir, the electrospinning solution including polyvinyl butyal and cyclopentane; the concentration of polyvinyl butyal in the electrospinning solution is 40 wt %.

Parameters of the electrospinning device are set, so that the electrospinning process parameters include a liquid flow rate of 10 mL/min, a spinning voltage of 100 kV, an ambient temperature of 25° C., and an ambient relative humidity of 20%.

Cyclopentane is injected into a solvent atomizing generator.

Parameters of the air quantity controller are set, so that air quantities of air inlets of sub-seal chambers along the jet advancing direction are 3 m³/h, 7 m³/h, 10 m³/h, 15 m³/h, 18 m³/h, 21 m³/h, 26 m³/h, 31 m³/h and 36 m³/h, respectively.

A certain amount of polymer is put into the polymer tank, and a certain amount of solvent is put into the solvent tank; the type and the addition amount of the polymer and the type and the addition amount of the solvent need to meet the following conditions: after the device is started, a flash-spinning solution is formed in a high-temperature and high-pressure reaction kettle, the flash-spinning solution consisting of 35 wt % of polyethylene and a remainder of 1H,6H-perfluorohexane; the melt index of polyethylene in the flash-spinning solution at a temperature of 160° C. and under a load of 5 kg is 0.7 g/10 min, and the melting point of polyethylene is 133° C.

Parameters of the flash-spinning device are set, so that the flash-spinning process parameters include a reaction pressure of 30 MPa, a reaction temperature of 150° C., and a stirring speed of 1500 rpm.

Parameters of the hot-pressing upper roller and the hot-pressing lower roller are set, so that hot-pressing is performed on a whole consisting of nanofibers and micron fibers at a temperature of 110° C. for 0.7 min.

After the above preparations are made, the device is started, to prepare the flash-spun/electrospun composite superfine nanofiber material.

The flash-spun/electrospun composite superfine nanofiber material prepared as a whole has a film-like structure and consists of nanofibers having an average diameter of 760 nm and micron fibers having an average diameter of 20 m. The micron fibers are mutually entangled, curled and interpenetrated, and the nanofibers are uniformly interspersed and distributed within the micron fibers, some of the nanofibers and the micron fibers forming entangled and interpenetrated structures, with mutual bonding between the nanofibers, between the micron fibers and between the nanofibers and the micron fibers, and the mass ratio of the nanofibers to the micron fibers being 2:5; the strength of the flash-spun/electrospun composite superfine nanofiber material is 580 N/50 mm, the porosity is 93%, the moisture permeability is 5900 g/m² 24 h, and the water pressure resistance is 18 kPa.

### Embodiment 7

An enhanced flash-spinning/electrospinning composite device is basically the same as embodiment 1, with the difference only being that there are no first blowout device, no second blowout device, no solvent atomizing generator and no air quantity controller in embodiment 7.

In the preparation method of the flash-spun/electrospun composite superfine nanofiber material, the enhanced flash-spinning/electrospinning composite device is used. The following preparations are made before the device is started:

An electrospinning solution is injected into an electrospinning reservoir, the electrospinning solution including polyethylene, an organosilicon water repellent (Akzo Nobel SEAL 80), and DMF; the concentration of polyethylene in the electrospinning solution is 2 wt %; the concentration of the organosilicon water repellent in the electrospinning solution is 0.5 wt %.

Parameters of the electrospinning device are set, so that the electrospinning process parameters include a liquid flow rate of 1 mL/min, a spinning voltage of 30 kV, an ambient temperature of 23° C., and an ambient relative humidity of 90%.

A certain amount of polymer is put into the polymer tank, and a certain amount of solvent is put into the solvent tank; the type and the addition amount of the polymer and the type and the addition amount of the solvent need to meet the following conditions: after the device is started, a flash-spinning solution is formed in a high-temperature and high-pressure reaction kettle, the flash-spinning solution consisting of 2 wt % of polyethylene and a remainder of dichloromethane; the melt index of polyethylene in the flash-spinning solution at a temperature of 160° C. and under a load of 5 kg is 0.7 g/10 min, and the melting point of polyethylene is 133° C.

Parameters of the flash-spinning device are set, so that the flash-spinning process parameters include a reaction pressure of 8 MPa, a reaction temperature of 300° C., and a stirring speed of 500 rpm.

Parameters of the hot-pressing upper roller and the hot-pressing lower roller are set, so that hot-pressing is performed on a whole consisting of nanofibers and micron fibers at a temperature of 100° C. for 0.2 min.

After the above preparations are made, the device is started, to prepare the flash-spun/electrospun composite superfine nanofiber material.

The strength of the flash-spun/electrospun composite superfine nanofiber material prepared is 320 N/50 mm, the porosity is 68%, the moisture permeability is 830 g/m² 24 h, and the water pressure resistance is 9 kPa.

### Embodiment 8

An enhanced flash-spinning/electrospinning composite device is basically the same as embodiment 2, with the difference only being that in there are no first blowout device, no second blowout device, no solvent atomizing generator and no air quantity controller in embodiment 8.

In the preparation method of the flash-spun/electrospun composite superfine nanofiber material, the enhanced flash-spinning/electrospinning composite device is used. The following preparations are made before the device is started:

An electrospinning solution is injected into an electrospinning reservoir, the electrospinning solution including polyvinylidene fluoride, a C6 water repellent (KES Z-2001), and DMAc; the concentration of polyvinylidene fluoride in the electrospinning solution is 4 wt %; the concentration of the C6 water repellent (KES Z-2001) in the electrospinning solution is 1 wt %.

Parameters of the electrospinning device are set, so that the electrospinning process parameters include a liquid flow rate of 2 mL/min, a spinning voltage of 40 kV, an ambient temperature of 23° C., and an ambient relative humidity of 80%.

A certain amount of polymer is put into the polymer tank, and a certain amount of solvent is put into the solvent tank; the type and the addition amount of the polymer and the type and the addition amount of the solvent need to meet the following conditions: after the device is started, a flash-spinning solution is formed in a high-temperature and high-pressure reaction kettle, the flash-spinning solution consisting of 6 wt % of polyethylene and a remainder of 1H,6H-perfluorohexane; the melt index of polyethylene in the flash-spinning solution at a temperature of 160° C. and under a load of 5 kg is 0.7 g/10 min, and the melting point of polyethylene is 133° C.

Parameters of the flash-spinning device are set, so that the flash-spinning process parameters include a reaction pressure of 13 MPa, a reaction temperature of 270° C., and a stirring speed of 700 rpm.

Parameters of the hot-pressing upper roller and the hot-pressing lower roller are set, so that hot-pressing is performed on a whole consisting of nanofibers and micron fibers at a temperature of 130° C. for 0.3 min.

After the above preparations are made, the device is started, to prepare the flash-spun/electrospun composite superfine nanofiber material.

The strength of the flash-spun/electrospun composite superfine nanofiber material prepared is 278 N/50 mm, the porosity is 62%, the moisture permeability is 990 g/m² 24 h, and the water pressure resistance is 10.6 kPa.

### Embodiment 9

An enhanced flash-spinning/electrospinning composite device is basically the same as embodiment 1, with the difference only being that in there are no partition plate, no solvent atomizing generator and no air quantity controller in embodiment 9.

In the preparation method of the flash-spun/electrospun composite superfine nanofiber material, the enhanced flash-spinning/electrospinning composite device is used. The following preparations are made before the device is started:

An electrospinning solution is injected into an electrospinning reservoir, the electrospinning solution including polyethylene, an organosilicon water repellent (Akzo Nobel SEAL 80), and DMF; the concentration of polyethylene in the electrospinning solution is 2 wt %; the concentration of the organosilicon water repellent in the electrospinning solution is 0.5 wt %.

Parameters of the electrospinning device are set, so that the electrospinning process parameters include a liquid flow rate of 1 mL/min, a spinning voltage of 30 kV, an ambient temperature of 23° C., and an ambient relative humidity of 90%.

A certain amount of polymer is put into the polymer tank, and a certain amount of solvent is put into the solvent tank; the type and the addition amount of the polymer and the type and the addition amount of the solvent need to meet the following conditions: after the device is started, a flash-spinning solution is formed in a high-temperature and high-pressure reaction kettle, and the flash-spinning solution consists of 2 wt % of polyethylene and a remainder of dichloromethane; the melt index of polyethylene in the flash-spinning solution at a temperature of 160° C. and under a load of 5 kg is 0.7 g/10 min, and the melting point of polyethylene is 133° C.

Parameters of the flash-spinning device are set, so that the flash-spinning process parameters include a reaction pressure of 8 MPa, a reaction temperature of 300° C., and a stirring speed of 500 rpm.

Parameters of the hot-pressing upper roller and the hot-pressing lower roller are set, so that hot-pressing is performed on a whole consisting of nanofibers and micron fibers at a temperature of 100° C. for 0.2 min.

After the above preparations are made, the device is started, to prepare the flash-spun/electrospun composite superfine nanofiber material.

The strength of the flash-spun/electrospun composite superfine nanofiber material prepared is 260 N/50 mm, the porosity is 58%, the moisture permeability is 880 g/m² 24 h, and the water pressure resistance is 8.1 kPa.

### Embodiment 10

An enhanced flash-spinning/electrospinning composite device is basically the same as embodiment 2, with the difference being that in there are no partition plate, no solvent atomizing generator and no air quantity controller in embodiment 10.

In the preparation method of the flash-spun/electrospun composite superfine nanofiber material, the enhanced flash-spinning/electrospinning composite device is used. The following preparations are made before the device is started:

An electrospinning solution is injected into an electrospinning reservoir, the electrospinning solution including polyvinylidene fluoride, a C6 water repellent (KES Z-2001), and DMAc; the concentration of polyvinylidene fluoride in the electrospinning solution is 4 wt %; the concentration of the C6 water repellent (KES Z-2001) in the electrospinning solution is 1 wt %.

Parameters of the electrospinning device are set, so that the electrospinning process parameters include a liquid flow rate of 2 mL/min, a spinning voltage of 40 kV, an ambient temperature of 23° C., and an ambient relative humidity of 80%.

A certain amount of polymer is put into the polymer tank, and a certain amount of solvent is put into the solvent tank; the type and the addition amount of the polymer and the type and the addition amount of the solvent need to meet the following conditions: after the device is started, a flash-spinning solution is formed in a high-temperature and high-pressure reaction kettle, and the flash-spinning solution consists of 6 wt % of polyethylene and a remainder of 1H,6H-perfluorohexane; the melt index of polyethylene in the flash-spinning solution at a temperature of 160° C. and under a load of 5 kg is 0.7 g/10 min, and the melting point of polyethylene is 133° C.

Parameters of the flash-spinning device are set, so that the flash-spinning process parameters include a reaction pressure of 13 MPa, a reaction temperature of 270° C., and a stirring speed of 700 rpm.

Parameters of the hot-pressing upper roller and the hot-pressing lower roller are set, so that hot-pressing is performed on a whole consisting of nanofibers and micron fibers at a temperature of 130° C. for 0.3 min.

After the above preparations are made, the device is started, to prepare the flash-spun/electrospun composite superfine nanofiber material.

The strength of the flash-spun/electrospun composite superfine nanofiber material prepared is 340 N/50 mm, the porosity is 69%, the moisture permeability is 1180 g/m² 24 h, and the water pressure resistance is 12 kPa.

### Embodiment 11

An enhanced flash-spinning/electrospinning composite device is basically the same as embodiment 1, with the difference only being that there are no hot-pressing upper roller and no hot-pressing lower roller which are located on the upper side and the lower side of the receiving conveyor belt in embodiment 11.

In the preparation method of the flash-spun/electrospun composite superfine nanofiber material, the enhanced flash-spinning/electrospinning composite device is used. The following preparations are made before the device is started:

An electrospinning solution is injected into an electrospinning reservoir, the electrospinning solution including polyethylene, an organosilicon water repellent (Akzo Nobel SEAL 80), and DMF; the concentration of polyethylene in the electrospinning solution is 2 wt %; the concentration of the organosilicon water repellent in the electrospinning solution is 0.5 wt %.

Parameters of the electrospinning device are set, so that the electrospinning process parameters include a liquid flow rate of 1 mL/min, a spinning voltage of 30 kV, an ambient temperature of 23° C., and an ambient relative humidity of 90%.

DMF is injected into a solvent atomizing generator.

Parameters of the air volume controller are set, so that air quantities of air inlets of the sub-seal chambers along the jet advancing direction are 10 m³/h, 18 m³/h, 32 m³/h, 36 m³/h and 40 m³/h, respectively.

A certain amount of polymer is put into the polymer tank, and a certain amount of solvent is put into the solvent tank; the type and the addition amount of the polymer and the type and the addition amount of the solvent need to meet the following conditions: after the device is started, a flash-spinning solution is formed in a high-temperature and high-pressure reaction kettle, the flash-spinning solution consisting of 2 wt % of polyethylene and a remainder of dichloromethane; the melt index of polyethylene in the flash-spinning solution at a temperature of 160° C. and under a load of 5 kg is 0.7 g/10 min, and the melting point of polyethylene is 133° C.

Parameters of the flash-spinning device are set, so that the flash-spinning process parameters include a reaction pressure of 8 MPa, a reaction temperature of 300° C., and a stirring speed of 500 rpm.

After the above preparations are made, the device is started, to prepare the flash-spun/electrospun composite superfine nanofiber material.

The strength of the flash-spun/electrospun composite superfine nanofiber material is 110 N/50 mm, the porosity is 75%, the moisture permeability is 1300 g/m² 24 h, and the water pressure resistance is 6 kPa.

### Embodiment 12

An enhanced flash-spinning/electrospinning composite device is basically the same as embodiment 2, with the difference only being that there are no hot-pressing upper roller and no hot-pressing lower roller which are located on the upper side and the lower side of the receiving conveyor belt in embodiment 12.

In the preparation method of the flash-spun/electrospun composite superfine nanofiber material, the enhanced flash-spinning/electrospinning composite device is used. The following preparations are made before the device is started:

An electrospinning solution is injected into an electrospinning reservoir, the electrospinning solution including polyvinylidene fluoride, a C6 water repellent (KES Z-2001), and DMAc; the concentration of polyvinylidene fluoride in the electrospinning solution is 4 wt %; the concentration of the C6 water repellent (KES Z-2001) in the electrospinning solution is 1 wt %.

Parameters of the electrospinning device are set, so that the electrospinning process parameters include a liquid flow rate of 2 mL/min, a spinning voltage of 40 kV, an ambient temperature of 23° C., and an ambient relative humidity of 80%.

DMAc is injected into a solvent atomizing generator.

Parameters of the air volume controller are set, so that air quantities of air inlets of the sub-seal chambers along the jet advancing direction are 12 m³/h, 20 m³/h, 34 m³/h, 38 m³/h and 44 m³/h, respectively.

A certain amount of polymer is put into the polymer tank, and a certain amount of solvent is put into the solvent tank; the type and the addition amount of the polymer and the type and the addition amount of the solvent need to meet the following conditions: after the device is started, a flash-spinning solution is formed in a high-temperature and high-pressure reaction kettle, the flash-spinning solution consisting of 6 wt % of polyethylene and a remainder of 1H,6H-perfluorohexane; the melt index of polyethylene in the flash-spinning solution at a temperature of 160° C. and under a load of 5 kg is 0.7 g/10 min, and the melting point of polyethylene is 133° C.

Parameters of the flash-spinning device are set, so that the flash-spinning process parameters include a reaction pressure of 13 MPa, a reaction temperature of 270° C., and a stirring speed of 700 rpm.

After the above preparations are made, the device is started, to prepare the flash-spun/electrospun composite superfine nanofiber material.

The strength of the flash-spun/electrospun composite superfine nanofiber material prepared is 105 N/50 mm, the porosity is 72%, the moisture permeability is 1280 g/m² 24 h, and the water pressure resistance is 5.5 kPa.

What is claimed is:

1. A preparation method of a flash-spun/electrospun composite superfine nanofiber material, comprising:
in processes of preparing nanofibers by using an electrospinning process and preparing micron fibers by using a flash-spinning process, controlling an electrospinning nozzle and a flash-spinning nozzle to be simultaneously located above a receiving conveyor belt, and to be directly opposite to each other with a spacing of 15-40 cm; and
controlling the electrospinning nozzle to be connected to a high-voltage power supply, and the flash-spinning nozzle and the receiving conveyor belt to be grounded, to prepare the flash-spun/electrospun composite superfine nanofiber material.

2. The preparation method according to claim 1, wherein an electrospinning solution comprises a polymer I and a solvent I; the polymer I is polyethylene, polyvinylidene fluoride, polyacrylonitrile, polyurethane or polyvinyl butyal, the solvent I is N,N-Dimethylformamide (DMF), Dimethylacetamide (DMAc), dichloromethane, 1H,6H-perfluorohexane, n-pentane or cyclopentane; and a concentration of the polymer I in the electrospinning solution is 2-40 wt %.

3. The preparation method according to claim 2, wherein the electrospinning solution further comprises a water repellent; the water repellent is an organosilicon water repellent, a C6 water repellent or a C8 water repellent; and a concentration of the water repellent in the electrospinning solution is 0.5-5 wt %.

4. The preparation method according to claim 2, wherein electrospinning process parameters comprise a liquid flow rate of 1-10 mL/min, a spinning voltage of 30-100 kV, an ambient temperature of 23-25° C., and an ambient relative humidity of 20%-90%.

5. The preparation method according to claim 1, wherein a flash-spinning solution consists of 2-35 wt % of polymer II and a remainder of solvent II; the polymer II is polyethylene with a melt index of 0.7 g/10 min at a temperature of 160° C. and under a load of 5 kg, and a melting point of 133° C.; and the solvent II is dichloromethane, 1H,6H-perfluorohexane, n-pentane or cyclopentane.

6. The preparation method according to claim 5, wherein flash-spinning process parameters comprise a reaction pressure of 8-30 MPa, a reaction temperature of 150-300° C., and a stirring speed of 2500-1500 rpm.

7. The preparation method according to claim 1, wherein during electrospinning, irregular airflow blowing is applied to a jet ejected from the electrospinning nozzle; and during flash-spinning, irregular airflow blowing is applied to a jet ejected from the flash-spinning nozzle.

8. The preparation method according to claim 7, wherein during the electrospinning, a concentration of a solvent in an environment of a spinning region is controlled so that the concentration of the solvent in the environment gradually increases along the jet advancing direction.

9. The preparation method according to claim 8, wherein after the electrospinning and flash-spinning, hot-pressing is performed on a whole consisting of the nanofibers and the micron fibers at a temperature between a melting point of the nanofibers and a melting point of the micron fibers for 0.2-0.7 min.

10. A flash-spun/electrospun composite superfine nanofiber material prepared by using the preparation method according to claim 9, wherein the flash-spun/electrospun composite superfine nanofiber material as a whole has a film-like structure and consists of nanofibers and micron fibers; the micron fibers are mutually entangled, curled and interpenetrated, and the nanofibers are uniformly interspersed and distributed within the micron fibers, a part of the nanofibers and a part of the micron fibers forming entangled and interpenetrated structures; mutual bonding are formed between the nanofibers, between the micron fibers and between the nanofibers and the micron fibers; and a mass ratio of the nanofibers to the micron fibers is 1:5-2.5;
an average diameter of the nanofibers is 50-800 nm, and an average diameter of the micron fibers is 1-20 m; the flash-spun/electrospun composite superfine nanofiber material has a strength greater than 100 N/50 mm, a porosity greater than 55%, a moisture permeability greater than 800 g/m² 24 h, and a water pressure resistance greater than 5 kPa.
